(19) United States
(12) Patent Application Publication
(10) Pub. No.: US 2026/0032609 A1
(43) Pub. Date: Jan. 29, 2026

(54) TECHNOLOGIES FOR SYNCHRONIZATION SIGNAL BLOCK ADAPTATION

(71) Applicant: Apple Inc., Cupertino, CA (US)

(72) Inventors: Hong He, San Jose, CA (US); Chunxuan Ye, San Diego, CA (US); Dan Wu, Beijing (CN); Weidong Yang, San Diego, CA (US); Wei Zeng, Saratoga, CA (US); Dawei Zhang, Saratoga, CA (US); Ankit Bhamri, Haar (DE); Haitong Sun, Saratoga, CA (US)

(73) Assignee: Apple Inc., Cupertino, CA (US)

(21) Appl. No.: 19/246,644

(22) Filed: Jun. 23, 2025

Related U.S. Application Data
(60) Provisional application No. 63/674,644, filed on Jul. 23, 2024.

(51) Int. Cl. H04W 56/00; H04W 72/231; H04W 76/20; H04W 80/02

(52) U.S. Cl. CPC H04W 56/0015; H04W 72/231; H04W 76/20; H04W 80/02

(57) ABSTRACT

The present application relates to devices and components including apparatus, systems, and methods for hybrid synchronization signal block.

### CROSS-REFERENCE TO OTHER APPLICATION

This application claims priority to U.S. Provisional Application No. 63/674,644, for “TECHNOLOGIES FOR SYNCHRONIZATION SIGNAL BLOCK ADAPTATION” filed on Jul. 23, 2024, which is herein incorporated by reference in its entirety for all purposes.

### TECHNICAL FIELD

This application relates generally to communication networks and, in particular, to synchronization signal blocks.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates Type-2 on-demand (OD)-synchronization signal block (SSB) configurations in accordance with some embodiments.

FIG. 3 illustrates a timing diagram in accordance with some embodiments.

FIG. 4 illustrates several options for control information in accordance with some embodiments.

FIG. 5 illustrates another timing diagram in accordance with some embodiments.

FIG. 6 illustrates several examples of timing diagrams in accordance with some embodiments.

FIG. 7 illustrates another control information in accordance with some embodiments.

FIG. 8 illustrates several options for configuring measurement occasions in accordance with some embodiments.

FIG. 9 illustrates a signaling diagram in accordance with some embodiments.

FIG. 10 illustrates another signaling diagram in accordance with some embodiments.

FIG. 11 illustrates an operation flow/algorithmic structure in accordance with some embodiments.

FIG. 12 illustrates another operation flow/algorithmic structure in accordance with some embodiments.

FIG. 13 illustrates a user equipment in accordance with some embodiments.

FIG. 14 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

Network energy savings (NES) features are aimed at reducing the energy consumption of cellular networks. NES features may reduce the operational cost of running cellular networks, reduce carbon emissions, promote environmental sustainability, optimize the utilization of network resources, or maintain quality of service (QoS). NES techniques such as dynamic power management, sleep mode operations, dynamic carrier aggregation activation or deactivation, or traffic offloading are specified in several 3GPP TSs.

NES considered for Release 19 NR include providing carrier aggregation with on-demand SSB transmissions on the SCell and for non-anchor primary cell (PCell). With respect to on-demand SSB, it will be limited to CONNECTED UEs in SCell for both intra- and inter-band carrier aggregation. The contemplated triggering method will include a UE uplink wake-up signal (WUS) that uses an existing signal/channel.

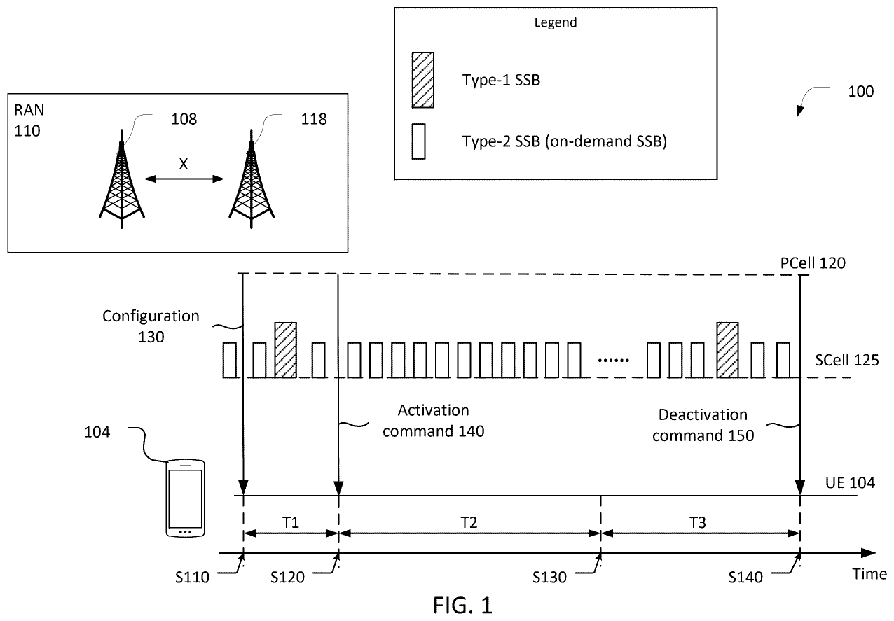

FIG. 1 illustrates a network environment 100 in accordance with some embodiments. The network environment 100 may include a UE 104 coupled with a base station (BS) 108 of a radio access network (RAN) 110 that provides one or more serving cells. In some embodiments, the BS 108 is a gNB that provides one or more 3GPP NR cells. The air interface over which the UE 104 and the base station 108 communicate may be compatible with 3GPP technical specifications (TSs), such as those that define 5G NR or later system standards (e.g., Sixth Generation (6G) standards). RAN 110 may include a number of base stations (e.g., the base stations 108 and 118) or other access nodes that provide services to various UEs through serving cells.

The initial cell with which the UE 104 establishes its connection during the initial connection establishment procedure may be referred to as primary cell (PCell) 120. A secondary cell (SCell) 125 may be a cell in addition to the PCell 120 that can be configured after the initial connection is established. In carrier aggregation scenarios, SCell 125 is aggregated with the PCell 120 to increase overall bandwidth and improve data rates. In some instances, SCell 125 may be a neighbor cell that the UE 104 monitors. In some embodiments, PCell 120 and SCell 125 may be provided by different base stations, e.g., PCell 120 provided by base station 108 and SCell 125 provided by base station 118.

The base station 108 may transmit several reference signals. One such signal may be the primary synchronization signal (PSS). The UE 104 may obtain the cell identity from the PSS. Another reference signal may be a secondary synchronization signal (SSS). The UE 104 may obtain frame timing from SSS. Once the UE 104 is synchronized with the cell, the UE 104 may receive system information, including master information block (MIB) and system information blocks (SIBs). The base station 108 may transmit MIB and SIBs on a physical broadcast channel (PBCH). The collection of PSS, SSS, and PBCH may be referred to as synchronization signal block (SSB). A cell may include one or more SSBs. Each SSB in a cell may be associated with a beam. The network, e.g., RAN 110 or the base stations 108 or 118, may configure, activate, or deactivate the SSBs.

Primary cell 120 may periodically transmit SSBs. SCell 125 may support periodic SSBs (Type-1 SSB) with a larger periodicity, e.g., to save energy. Alternatively, SCell 125 may also support on-demand SSB transmission (e.g., aperiodic or semi-persistent SSB transmission, which may also be called Type-2 SSB). An aperiodic on-demand SSB transmission may include one or more transmission occasions of the SSB. A semi-persistent on-demand SSB transmission may be similar to a periodic SSB transmission. Semi-persistent may be started or triggered when the UE 104 receives an activation command (e.g., activation command 140) from base station 108 and may be stopped when the UE 104 receives a deactivation command (e.g., deactivation command 150).

The resources allocated for the transmission of SSBs may be referred to as SSB occasions. The resources may include time-frequency resources, sequences, or reference signals. For example, resources for Type-1 SSBs may be referred to as Type-1 SSB occasions, or similarly, resources for on-demand SSB may be referred to as on-demand SSB occasions.

In some embodiments, the SCell 125 is aggregated with PCell 120 in an intra-band or inter-band carrier aggregation scenario. UE 104 may be configured (e.g., by configuration 130) with an SSB-based measurement timing configuration (SMTC) window. The SMTC window is a time interval during which the UE 104 is configured to measure the SSB. The UE 104 may use the persistent or periodic SSBs or on-demand (e.g., aperiodic or semi-persistent) SSBs on SCell 125 received during the SMTC window for Layer 1 (L1) or Layer 3 (L3) measurements.

L3 measurements may be used for mobility management, radio resource management (RRM), quality of service (QoS) optimization, network planning optimization, or inter-radio access technology (RAT) coordination. L3 measurements may include reference signal receive power (RSRP), reference signal received quality (RSRQ), or signal-to-interference and noise ratio (SINR).

In some embodiments, two types of SSBs are configured and used for SCell 125: Type-1 SSB or periodic SSB and Type-2 or on-demand SSB. Type-1 SSB is transmitted periodically, but the periodicity is larger than the default SSB periodicity (e.g., 20 milliseconds (ms)). Periodic SSB may be used for cell selection, reselection, or L3 measurement to trigger SCell activation or deactivation.

On-demand SSB may be sent by the network based on an SCell 125 activation procedure. For example, the transmission of the on-demand SSB may start when it is determined that the SCell 125 is to-be activated. This may coincide with the configuration of the SCell 125 by radio resource control (RRC) signaling, triggering activation of the SCell 125 by media access control (MAC) control element (CE), or another event. On-demand SSB may be used for radio link monitoring (RLM), beam management, and RRM (e.g., handover or cell switch).

In some embodiments, at time S110, the UE 104 may receive and process a configuration 130. Base station 108 may generate and transmit the configuration 130 on PCell 120 to UE 104. Configuration 130 may include configuration information for setting up or configuring SCell 120. The configuration information may include information elements for configuring Type-1 and Type-2 SSBs on SCell 125. In some embodiments, configuration 130 may trigger or activate Type-2 SSB. When activated, UE 104 is expected to monitor, receive, and process Type-2 SSBs transmitted by base station 108.

For example, UE 104 may use Type 2 SSBs transmitted on SCell 125 during the T1 interval to perform RLM measurements. UE 104 may generate and transmit a measurement report to base station 108. Based on the measurement report, base station 108 may determine whether to activate SCell 125. In some instances, base station 108 may determine to activate SCell 125 and send an activation command 140.

At time S120, UE 104 may receive and process the activation command 140. Base station 108 may generate and transmit activation command 140 on PCell 120 to UE 104. Activation command 140 may activate SCell 125 (from among several SCell configurations received in configuration 130). In some embodiments, activation command 140 may also activate on-demand SSB. In some instances, the on-demand SSBs during the T1 interval are beneficial due to their generally shorter periodicity than the type-1 (periodic) SSBs for radio link monitoring.

In some instances, it may take some time after receiving activation command 140 for SCell 125 to be activated. At time S130, SCell 125 is activated. During the time interval T2, e.g., between S120 and S130, UE 104 may use measurements based on on-demand SSB to support RRC connected mode functionalities. For example, on-demand SSB measurement may support beam management, dual connectivity and carrier aggregation, or RLM.

After SCell 125 is activated, e.g., during interval T3, UE 104 may perform measurements using on-demand SSBs and report the measurements to base station 108. Base station 108 may use the measurement reports and other information, e.g., traffic load, to trigger handover or to deactivate SCell 125. At time S140, UE 104 may receive and process deactivation command 150 to deactivate SCell 125. Base station 108 may generate and transmit deactivation command 150, indicating that SCell 125 is to be deactivated.

It is desired that mechanisms be specified for triggering or activating the on-demand SSBs to enable their operation.

In some embodiments, PCell 120 is provided by one base station, e.g., base station 108, and SCell 125 is provided by another base station, e.g., base station 118. Base station 118 may inform base station 108 of the configuration of on-demand SSB on SCell 125. In some embodiments, base station 118 may use an interface, e.g., X interface, to send the on-demand SSB configuration to base station 108. In some embodiments, UE 104 may use the periodic (Type-1) SSB or on-demand SSB occasions for inter-cell measurements (e.g., for handover). Enhancement of neighbor cell measurement to achieve reliable measurement for handover triggering is desirable.

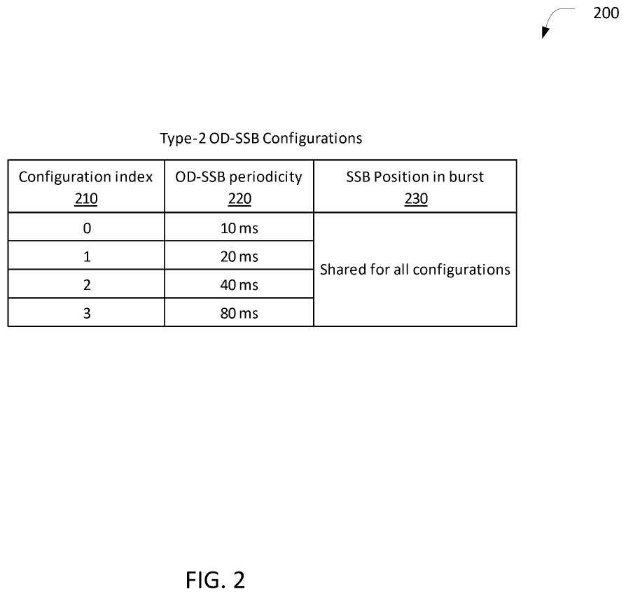

FIG. 2 illustrates Type-2 on-demand (OD)-SSB configurations 200 in accordance with some embodiments. Base station 108 may configure UE 104 with one or more of the Type-2 OD-SSB configurations 200. Base station 108 may generate and transmit configuration information to UE 104, and UE 104 may receive and process configuration information sent by base station 108. Each on-demand SSB configuration may include an on-demand SSB pattern. For example, base station 108 may use RRC signaling to configure on-demand SSB patterns.

The on-demand SSB pattern may include an OD-SSB periodicity 220. The OD-SSB periodicity 220 may define the interval between consecutive SSB transmissions within a serving cell. The OD-SSB periodicity 220 may be used to define the interval between consecutive SSB transmissions in an aperiodic on-demand SSB with more than one SSB occasion or the time interval between the SSB occasions for a semi-persistent on-demand SSB. An RRC information element (IE), for example, ssb-PeriodicityServingCell, may configure the periodicity of the on-demand SSBs (e.g., SSB occasions).

The on-demand SSB pattern may include a position in burst parameter 230 that indicates the position or index of a specific SSB within an SSB burst. An SSB burst may refer to a group of SSBs transmitted within a certain time period, and each SSB may have a unique position within this burst. An RRC IE PositionInBurst may be used to configure the SSB position in burst.

In some embodiments, the SSB position in burst parameter 230 of the on-demand SSB pattern configuration may be used to indicate which SSBs are being transmitted after the on-demand SSB is triggered. In some instances, a single SSB position in burst parameter 230 may be shared for all configured Type-2 on-demand SSBs.

In some embodiments, when more than one Type-2 on-demand SSB (e.g., on-demand SSB patterns) is configured, an on-demand SSB triggering command may select or activate one configuration. For example, the triggering command may include the index of selected or activated on-demand SSB pattern.

For example, in FIG. 2, four on-demand SSB patterns are configured. The configuration index 210 identifies the index of each configured on-demand SSB pattern. The on-demand SSB periodicity 220 identifies the periodicity of each configured on-demand SSB pattern, and the SSB position in burst 230 determines the position of the SSB within the SSB burst. In one example, the on-demand SSB pattern with configuration index 0 has a periodicity of 10 ms, the SSB pattern with configuration index 1 has a periodicity of 20 ms, the SSB pattern with configuration 2 has a periodicity of 40 ms, and the SSB pattern with configuration index 3 has a periodicity of 80 ms. According to the SSB position in burst 230, all on-demand SSB patterns share the same position within the SSB burst.

Three alternatives are considered to trigger or activate on-demand SSB transmission. Alternative 1 uses RRC signaling, alternative 2 uses medium access control (MAC) control element, and alternative 3 uses downlink control information (DCI) to trigger or activate on-demand SSB transmission.

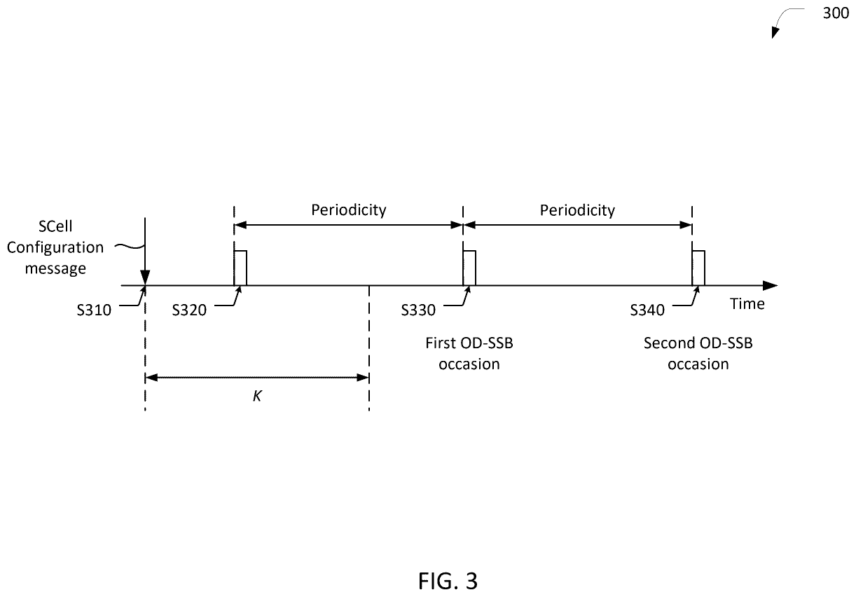

FIG. 3 illustrates a timing diagram 300 in accordance with some embodiments. The timing diagram 300 is associated with on-demand SSB operation when it is triggered or activated by RRC signaling. An IE may be added to the SCell configuration to indicate which on-demand SSB is activated. For example, a Type2-OD-SSB IE may be used to trigger an on-demand SSB pattern. The Type2-OD-SSB IE may take an integer value and its value may be the index of a configured on-demand SSB pattern. In some embodiments, the absence of this IE may indicate that Type-2 on-demand SSB transmission is not enabled. In some instances, the absence of this IE may indicate that Type-2 on-demand SSB transmission is not enabled for the corresponding configured SCell if an activation command of the SCell is not received.

In some instances, the on-demand SSB activation is included in the same RRC message configuring the SCell. In some instances, SSB activation IE and the corresponding SCell configuration may be included in separate RRC messages.

At S310, UE 104 may receive a message including SCell configuration. The SCell configuration may configure on-demand SSBs (e.g., on-demand SSB patterns). The SCell configuration may include an on-demand SSB trigger, activating a configured on-demand SSB. For example, in slot n, UE 104 may receive a physical downlink shared channel (PDSCH) containing SCell configuration RRC message.

In some embodiments, UE 104 is not expected to receive an on-demand SSB until slot n+K. The gap between receiving the PDSCH in slot n and Type-2 on-demand SSB transmission is at least K slots, where K=T_{RRC_Process}+T, T_{RRC_Process} is the RRC processing delay defined in 3GPP TSs, and T is the delay from slot T_{RRC_Process}+n until the UE 104 generates and sends the reconfiguration complete message, e.g., RRCReconfigurationComplete message. In some instances, base station 108 may generate and transmit on-demand SSBs during the configured on-demand SSB occasion between slot n and slot n+K, e.g., at S320. However, UE 104 may not be expected to monitor, receive, or process an on-demand SSB transmission during this time interval on a configured on-demand SSB occasion; e.g., UE 104 may not receive or process the on-demand SSB sent at S320.

Time S330 may be the first on-demand SSB occasion. UE 104 may monitor, receive, and process the transmitted SSB at S330 based on the Type-2 on-demand SSB configuration. Similarly, time S340 may be the next, e.g., the second on-demand SSB occasion that UE 104 may monitor, receive, and process the transmitted SSB. The time between S330 and S340 is the periodicity of the on-demand SSB pattern consistent with the configured and activated/triggered on-demand SSB pattern.

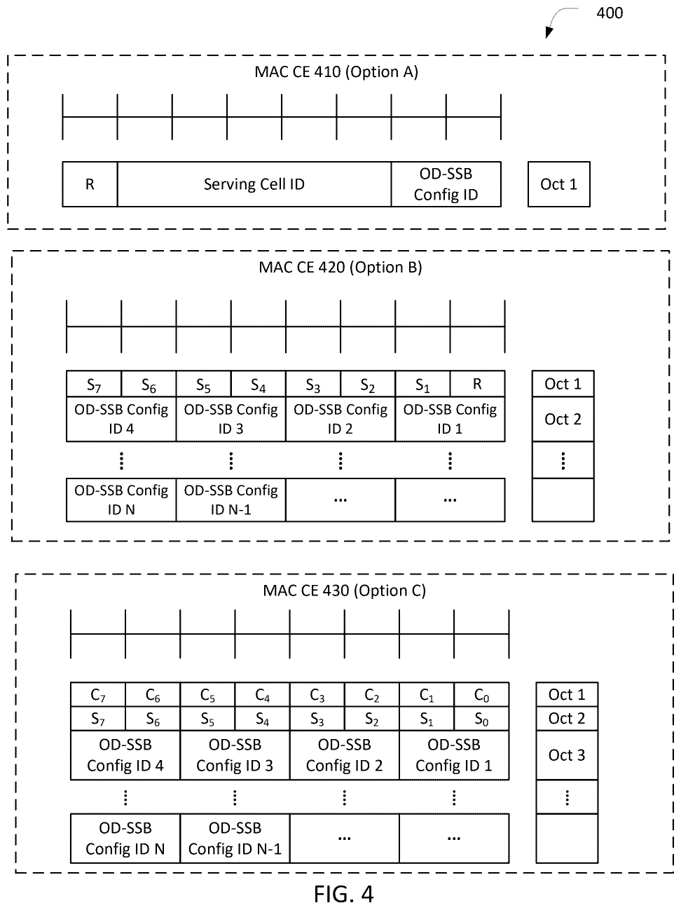

FIG. 4 illustrates several options 400 for control information in accordance with some embodiments. The on-demand SSBs are configured by RRC signaling for the SCell and MAC CE is used for activating or deactivating them. In some instances, MAC CE may be used to trigger on-demand SSB before the corresponding SCell is activated. In particular, options 400 includes three options for MAC CE structure for activating or deactivating on-demand SSB operation. A MAC sub header may identify the on-demand SSB activation MAC CE with a dedicated logical channel identifier (LCID). The dedicated LCID may be used to differentiate the MAC CE for activation or deactivation of on-demand SSB from other types of MAC CE.

In option A, MAC CE 410 may be used to activate on-demand SSB in a single cell. MAC CE 410 may have a fixed size, e.g., 1 octet. MAC CE 410 may include a serving cell identifier (ID) indicating the ID of the serving cell for which the on-demand SSB is activated. For example, MAC CE 410 may include five bits to indicate the serving cell ID.

MAC CE 410 may include an on-demand SSB configuration ID indicating the ID or index of a configured Type-2 on-demand SSB configuration that is being triggered or activated by MAC CE 410. For example, the value of this field may be the value of a configuration index 210 in FIG. 2.

MAC CE 410 may include one or more reserved bits denoted by R. In some instances, reserved bits may be set to zero (0). UE 104 may not be expected to process the reserved bits. In option A, MAC CE 410 may have a fixed size, e.g., one octet.

In option B, MAC CE 420 may be used to activate on-demand SSBs of multiple cells. MAC CE 420 may have a variable size. One or more octets in MAC CE 420 may provide a bitmap where each bit may correspond to an SCell. For example, S₁ may be associated with a first SCell, S₂ with a second SCell, and S₃-S₇ to corresponding third to seventh SCell. If the value of the Sᵢ is set to ‘1’, it may indicate that the on-demand SSB configuration (e.g., the on-demand SSB patterns) on the i-th SCell is triggered or activated. Similarly, if the value of the Sᵢ is set to ‘0’, it may indicate that the on-demand SSB configuration on the i-th SCell is deactivated or not activated.

In some instances, Sᵢ is a one-bit field. When the value of the of the Sᵢ is set to ‘1’, it may indicate that the on-demand SSB configuration (e.g., the on-demand SSB patterns) on the i-th SCell is present, e.g., on-demand SSB is configured for the i-th SCell. Similarly, if the value of the Sᵢ is set to ‘0’, it may indicate that the on-demand SSB configuration on the i-th SCell is not present, e.g., on-demand SSB is not configured for the i-th SCell.

As described in FIG. 2 above, each SCell may be configured with multiple on-demand SSB configurations (e.g., patterns). For example, each SCell may be configured with four on-demand SSB patterns. Once on-demand SSB configuration is activated on the i-th SCell by the Sᵢ bit, the OD-SSB Config ID fields in MAC CE 420 may determine which on-demand SSB pattern is activated. The OD-SSB configuration ID field may indicate the ID associated with the OD-SSB configuration. For example, two bits can be used to identify which one of four on-demand SSB patterns are activated.

The OD-SSB configuration IEs in the MAC CE 420 are associated with SCells that the corresponding Sᵢ fields is set to ‘1’ in increasing order of i values. For example, assume that S₁ is ‘0,’ S₂ is ‘1,’ S₃ is ‘0,’ and S₄ is ‘1.’ Then the first OD-SSB configuration IE, e.g., OD-SSB Configure ID 1, is associated with S₂, and the second OD-SSB configuration IE, e.g., OD-SSB Configure ID 2, is associated with S₃.

In some instances, Sᵢ is a one-bit field. When the value of the of the Sᵢ is set to ‘1’, it may indicate that the on-demand SSB configuration (e.g., the on-demand SSB patterns) on the i-th SCell is present, e.g., on-demand SSB is configured for the i-th SCell. Similarly, if the value of the Sᵢ is set to ‘0’, it may indicate that the on-demand SSB configuration on the i-th SCell is not present, e.g., on-demand SSB is not configured for the i-th SCell.

In option C, MAC CE 430 may be used to activate or deactivate on-demand SSBs of multiple cells and activate or deactivate SCells. The Sᵢ fields and OD-SSB Configure ID fields in the MAC CE 430 are the same as described above in MAC CE 420. MAC CE 430 may include Cⱼ fields for activating or deactivating SCells. Each bit may correspond to an SCell. For example, C₁-C₇ in MAC CE 430 may correspond to seven SCells, e.g., the first SCell to the seventh SCell. If Cᵢ is set to ‘0’, the i-th SCell is not activated or deactivated; if Cᵢ is set to ‘1,’ the i-th SCell is activated.

In option B or C, the MAC CE 420 or 430 may have a variable size. The size of MAC CE may be in number of bits or number of octets.

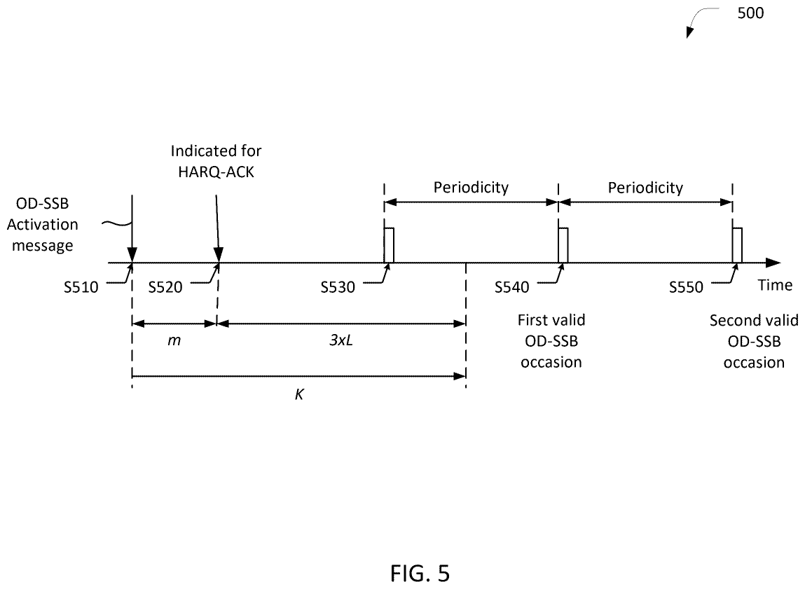

FIG. 5 illustrates another timing diagram 500 in accordance with some embodiments. In particular, timing diagram 500 shows the timing for expecting valid on-demand SSB occasions when on-demand SSB configuration is activated by MAC CE, such as MAC CE 410, 420, or 430 in FIG. 4 and described above.

At S510 (e.g., at slot n), UE 104 may receive an on-demand SSB activation message, e.g., MAC CE 410, 420, or 430. For example, the base station 108 may generate and transmit the PDSCH containing on-demand SSB activation MAC CE and the UE 104 may receive and process the PDSCH. UE 104 is not expected to monitor, receive, or process an on-demand SSB occasion for at least K slots, e.g., until slot n+K, where K=m+3·L. Slot n+m, e.g., at S520, is the slot indicated for hybrid automatic repeat request (HARQ)-acknowledgment (ACK) feedback, and L is the number of slots per subframe for the configured subcarrier spacing (SCS).

At S530, which is less than K slots after receiving the on-demand SSB activation message, UE 104 is not expected to receive an on-demand SSB occasion. UE 104 may receive a first valid on-demand SSB occasion at S540 and the second valid on-demand SSB occasion at S550. The time interval between the first and second valid on-demand SSB occasions is the periodicity of the activated n-demand SSB pattern.

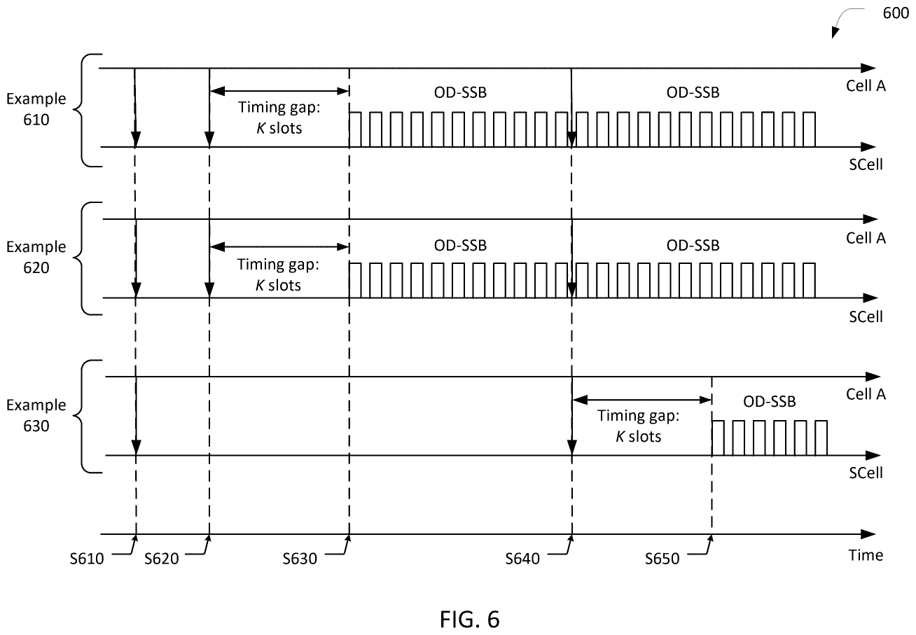

FIG. 6 illustrates several examples 600 of timing diagrams in accordance with some embodiments. In particular, examples 600 shows the timing impact of activation of on-demand SSB configuration and activation of corresponding SCells using MAC CE, e.g., options A, B, or C in FIG. 5 described above.

In all three examples, 610, 620, and 630, UE 104 receives the SCell configuration via RRC message at S610. The SCell configuration may include one or more on-demand SSB configurations (e.g., patterns) for each configured SCell.

In example 610, at S620, UE 104 may receive an on-demand SSB activation MAC CE, e.g., MAC CE 410 or 420 in FIG. 4 (e.g., option A and B MAC CEs). The activation MAC CE may activate one of the configured on-demand SSB patterns for the corresponding SCell. At S620, the SCell associated with the activated on-demand SSB may not yet be activated.

At S630, e.g., after a timing gap of K slots, UE 104 may start receiving on-demand SSB (e.g., aperiodic or semi-persistent SSBs) consistent with the configuration parameters of the activated on-demand SSB pattern.

At S640, UE 104 may receive a message activating the SCell associated with the activated on-demand SSB configuration. For example, UE 104 may receive legacy MAC CE activating the SCell. Base station 108 may receive the measurement report associated with the on-demand SSB occasions between S630 and S640 to decide whether to activate the corresponding SCell.

In example 620, at S620, UE 104 may receive an on-demand SSB activation MAC CE, e.g., MAC CE 430 in FIG. 4. The activation MAC CE may activate one of the configured on-demand SSB patterns for the corresponding SCell. The received MAC CE at S620 does not activate the corresponding SCell in this example.

At S630, e.g., after a timing gap of K slots, UE 104 may start receiving on-demand SSB (e.g., aperiodic or semi-persistent SSBs) consistent with the configuration parameters of the activated on-demand SSB pattern.

At S640, UE 104 may receive another option, C MAC CE, to activate the SCell associated with the activated on-demand SSB configuration. For example, UE 104 may receive a MAC CE 430 activating the SCell. Base station 108 may receive the measurement report associated with the on-demand SSB occasions between S630 and S640 to decide whether to activate the corresponding SCell.

In example 630, at S640, UE 104 may receive a MAC CE, e.g., MAC CE 430 in FIG. 4. The activation MAC CE may activate one of the configured on-demand SSB patterns for the corresponding SCell and also activate the corresponding SCell.

At S650, e.g., after a timing gap of K slots, UE 104 may receive on-demand SSB (e.g., aperiodic or semi-persistent SSBs) consistent with the configuration parameters of the activated on-demand SSB pattern.

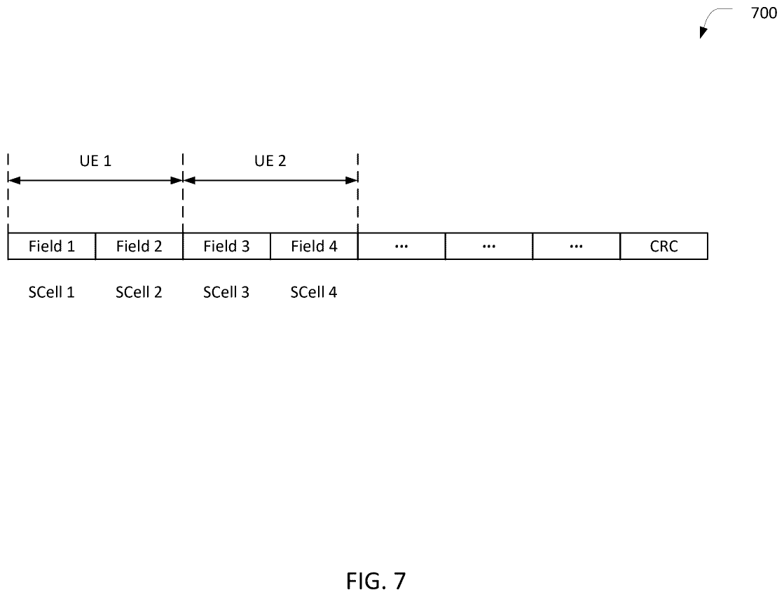

FIG. 7 illustrates control information 700 in accordance with some embodiments. Control information 700 is an example of a DCI used to activate on-demand SSB configuration on an SCell.

In some embodiments, base station 108 may generate and transmit the DCI 700 to another activated cell, e.g., a PCell.

In some embodiments, a DCI format x_1 or x_0 may be used to activate Type-2 on-demand SSB. The DCI 700 may include one or more cell indicator fields (CIFs) to indicate and ID, e.g., a cell ID, associated with the SCell for which the triggered on-demand SSB transmission is applied. The DCI 700 may include an on-demand SSB configuration ID to indicate the ID of the activated Type-2 on-demand SSB configuration or pattern. For example, field 1 may be the CIF, and field 2 may be the on-demand SSB configuration ID.

In some embodiments, the base station 108 may generate and transmit the DCI 700 on a serving cell that is different from the SCell on which the on-demand SSB is configured. For example, base station may generate and transmit the DCI 700 on a primary cell (PCell) to configure the on-demand SSB for an SCell.

In some embodiment, a UE-specific DCI format, e.g., DCI format 1_1, without scheduling data, may be used to trigger the Type-2 on-demand SSB transmission on one or multiple SCells. The frequency domain resource allocation (FDRA) field of the DCI 700 may be set to all ‘1s’ when Type-1 resource allocation is used and may be set to all ‘0s’ when Type-0 resource allocation is used. UE 104 may use the FDRA field to validate that DCI 700 is used to trigger on-demand SSB. The modulation and coding scheme (MCS), new data indicator, redundancy version, HARQ process number, antenna ports, demodulation reference signal sequence initialization fields of the validated DCI format 1_1 may be used for on-demand SSB triggering to indicate the SCell ID and the corresponding activated on-demand SSB configuration. Each bit may correspond to one or the configured SCells with the most significant bit (MSB) to least significant bit (LSB) of the concatenated fields corresponding to the SCells with the lowest to highest SCell index. DCI 700 may include an on-demand configuration ID field that indicates an ID associated with the on-demand SSB configuration.

In some embodiments, a group-specific DCI format may be used for Type-2 on-demand SSB triggering on one or more cells of one or more UEs. A dedicated radio network temporary identifier (RNTI) may identify the group-specific DCI format. The dedicated RNTI may be used to scramble the cyclic redundancy check (CRC) bits of the DCI 700.

One or more fields of the DCI 700 may be assigned to a first UE (UE 1) and one or more other fields of the DCI 700 may be assigned to a second UE (UE 2). For example, fields 1 and 2 in FIG. 7 are assigned to UE 1 and fields 3 and 4 are assigned to UE 2. Field 1 may be assigned to SCell 1 and can be used to trigger on-demand SSB on SCell 1 for UE 1. Similarly, field 2 may be assigned to SCell 2 and can be used to trigger on-demand SSB on SCell 2 for UE 1. Similarly, field 3 may be assigned to SCell 3 and can be used to trigger on-demand SSB on SCell 3 for UE 2, and field 4 may be assigned to SCell 4 and can be used to trigger on-demand SSB on SCell 2 for UE 2.

In some instances, RRC signaling may be used to provide the index to the on-demand SSB configuration indicator, e.g., how the value of a field in DCI 700 can be mapped to an on-demand SSB configuration. In some instances, the mapping may be specified in the 3GPP TSs. In some embodiments, the codepoint of all zeros may indicate that no Type-2 on-demand SSB is triggered for the corresponding cell.

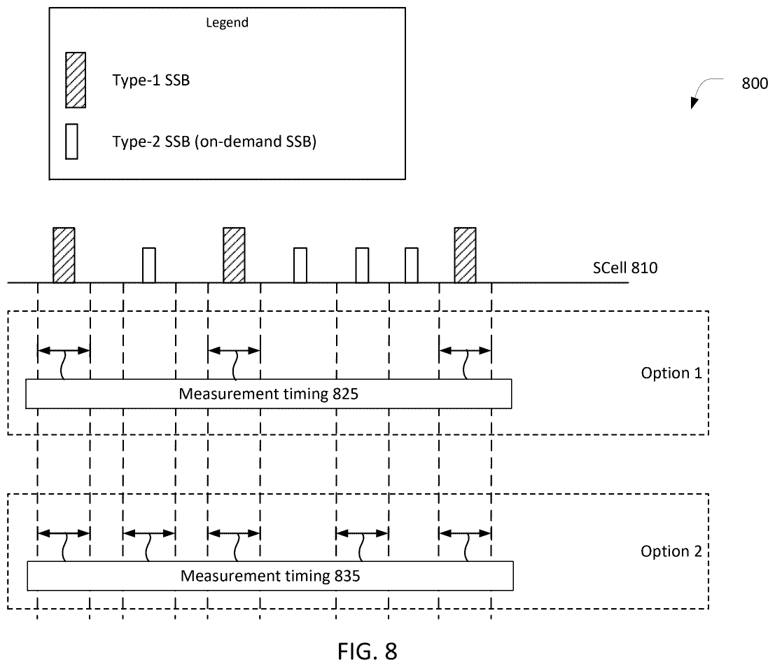

FIG. 8 illustrates several options 800 for configuring measurement occasions in accordance with some embodiments. Base station 108 may configure UE 104 with SMTC windows. UE 104 may measure on SSB occasions within the SMTC windows. UE 104 or base station 108 may use these measurements for cell switching operation.

In some embodiments, UE 104 may be connected to PCell associated with a first base station, e.g., base station 108, and may perform measurement on on-demand SSBs on an SCell 810 provided by another base station, e.g., base station 118. It may be beneficial that on-demand SSBs be transmitted during the configured SMTC window occasions.

In option 1, only the periodic Type-1 SSB occasions may be included in SSB measurement timing configuration. The network may determine SSB measurement timing 825 configuration (e.g., SMTC windows) and Type-1 SSB pattern to include a Type-1 SSB occasion during the SMTC window. In some instances, RRM measurement may perform an averaging operation across results from multiple measurement occasions to derive the filtered result.

In option 2, base stations 108 and 118 may communicate on an X interface. The X interface may be utilized to indicate or update the Type-2 on-demand SSB transmission configurations. For example, base station 108 may send the measurement timing 835 configuration, e.g., the SMTC window configuration, to base station 118, and base station 118 may use the measurement timing 835 configuration information, e.g., SMTC window configuration, to configure the Type-1 SSB and Type-2 on-demand SSB bursts.

In another example, base station 118 may provide the Type-1 and Type-2 SSB configurations on SCell 810 to base station 108 via the X interface. Base station 108 may use the Type-1 and Type-2 SSB configuration to configure or update the measurement timing 835 configuration, e.g., SMTC window configuration, to utilize the Type-1 or Type-2 SSB occasions for measurement.

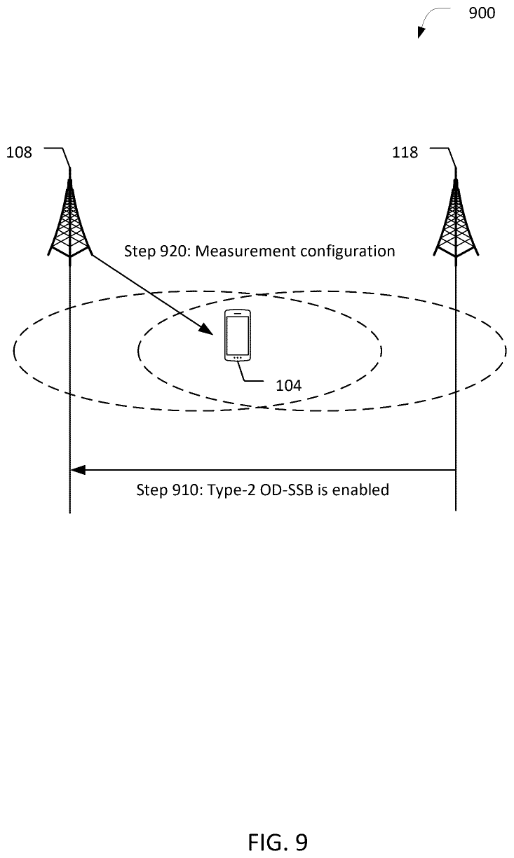

FIG. 9 illustrates a signaling diagram 900 in accordance with some embodiments. Signaling diagram 900 is an example of coordinating between base stations 108 and 118 to configure the Type-1 or Type-2 SSB occasions configured by one base station (e.g., base station 118) to align with the measurement timing (e.g., the SMTC window) configured by another base station (e.g., base station 108).

At 910, base station 118 may generate and send information to base station 108 to indicate that on-demand SSB is enabled on SCell. Base station 118 may send the information to base station 108 via an X interface.

At 920, base station 108 may generate measurement configuration and send it to UE 104. Measurement configuration may include measurement timing, e.g., SMTC window configuration. Base station 108 may generate measurement configuration based on the on-demand SSB configuration on SCell that were obtained on the X interface.

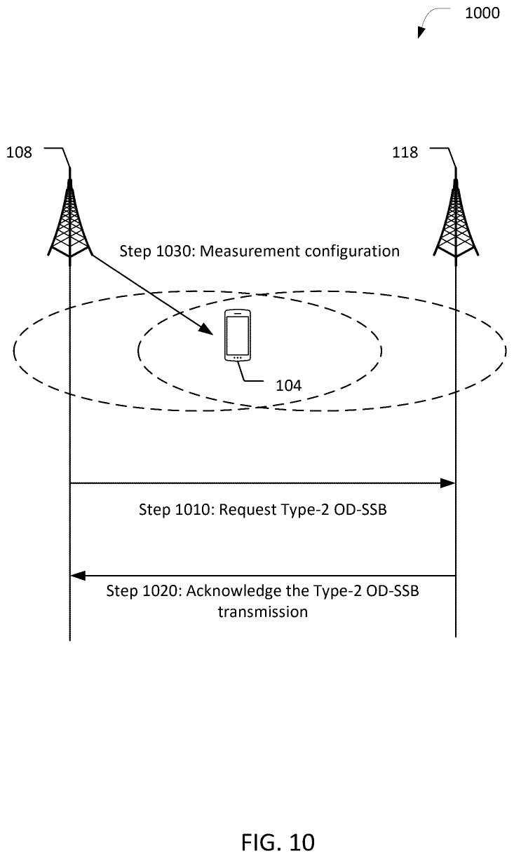

FIG. 10 illustrates another signaling diagram 1000 in accordance with some embodiments. Signaling diagram 1000 is an example of coordinating between base stations 108 and 118 for inter-cell measurement based on hybrid SSB patterns utilizing Type-1 and Type-2 on-demand SSB occasions. The inter-cell measurement is based a request-based transmission of Type-2 on-demand SSB transmission on a neighbor cell.

Once the Type-2 on-demand SSB is triggered on an SCell provided by base station 118, at step 1010, base station 108 may send a request to base station 118. UE 104 may use the Type-2 on-demand SSB occasion for RRM measurement to prepare for a handover.

At 1020, base station 118 may send an acknowledgment to base station 108 to confirm Type-2 on-demand SSB transmission. The acknowledgment may include configuration information for Type-2 on-demand SSB.

At 1030, base station 108 may configure the UE 104 with measurement occasions, e.g., SMTC window. Base station 108 may determine the measurement occasions configuration based on the Type-2 on-demand SSB configuration information received from base station 118 in the acknowledgment.

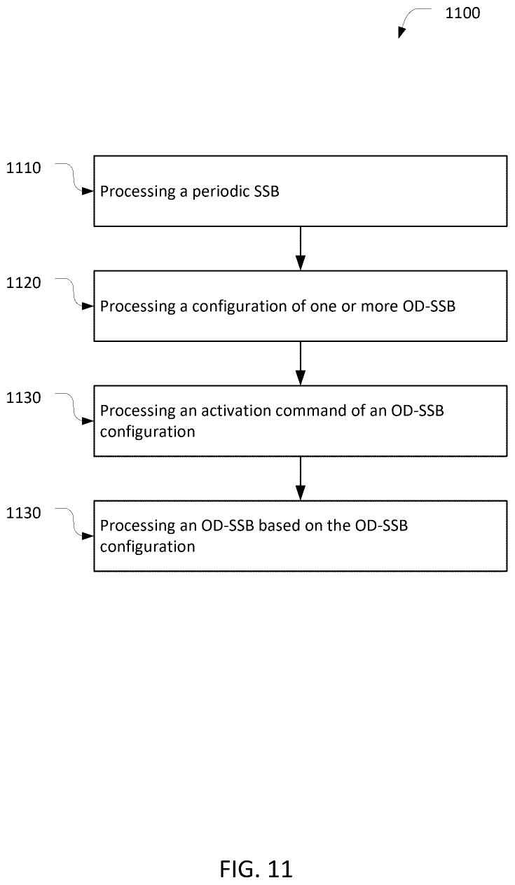

FIG. 11 illustrates an operation flow/algorithmic structure 1100 in accordance with some embodiments. The operation flow/algorithmic structure 1100 may be performed or implemented by a UE such as, for example, the UE 104 or UE 1300; or components thereof, for example, baseband processor circuitry 1304A.

The operation flow/algorithmic structure 1100 may include, at 1110, processing a periodic SSB. UE 104 may receive and process Type-1 SSBs, e.g., periodic SSBs on an SCell. The SCell may be configured but not being activated at the UE 104. In some embodiments, the UE 104 may receive the Type-1 SSB on SCell provided by base station 118 while connected to a PCell provided by base station 108.

The operation flow/algorithmic structure 1100 may include, at 1120, processing a configuration of one or more on-demand SSB configurations. Each on-demand SSB configuration may include an on-demand SSB pattern that has a periodicity or a position in SSB burst fields. The on-demand SSB configuration may be associated with the SCell.

In some embodiments, the configuration may be an RRC configuration. The RRC configuration may include one or more SCell configurations, and each SCell configuration may include one or more on-demand SSB configurations.

The operation flow/algorithmic structure 1100 may include, at 1130, processing an activation command. The activation command may trigger or activate a Type-2 on-demand SSB configuration of one or more on-demand SSB configurations of the SCell.

In some embodiments, the activation command may be an RRC signaling. For example, the RRC configuration that configures the SCell may include an IE to activate one of the configured on-demand SSB configurations.

In some embodiments, the activation command may be a MAC CE. The MAC CE may activate on-demand SSB configuration on a single cell or multiple cells. In some instances, the MAC CE may activate the SCell as well. The MAC CE may be used to deactivate the on-demand SSB configuration or the SCell. In some instances, activation or deactivation of on-demand SSB may be independent of activation or deactivation of the corresponding SCell.

In some embodiments, the activation command may be a DCI. The DCI may be a UE-specific DCI format (e.g., DCI format x_0 or x_1), a UE-specific format without scheduling data (e.g., DCI format 1_1), or a group-specific format.

The operation flow/algorithmic structure 1100 may include, at 1140, processing an on-demand SSB based on the activated on-demand SSB configuration. UE 104 may receive and process on-demand SSB occasions consistent with the activated on-demand SSB configuration K slots after receiving the on-demand SSB activation command.

In some embodiments, UE 104 may perform inter-cell measurements based on the periodic SSB or the on-demand SSB. UE 104 may utilize Type-1 or Type-2 on-demand SSB occasions for measurement.

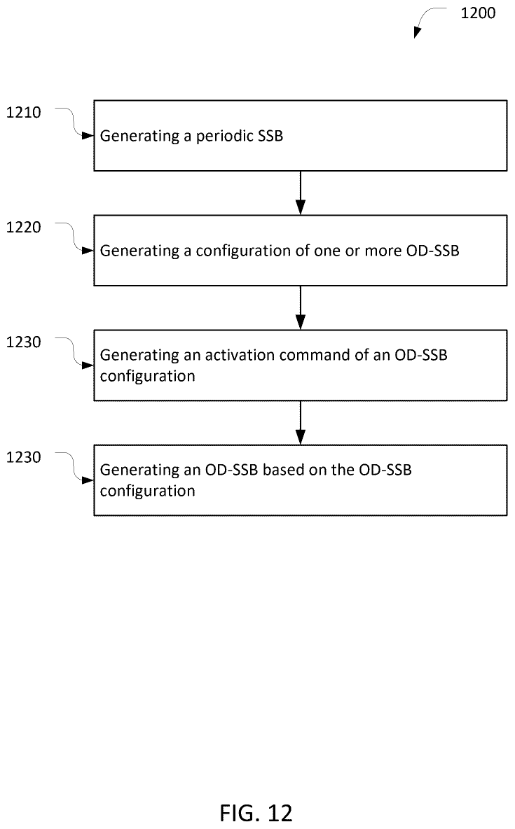

FIG. 12 illustrates another operation flow/algorithmic structure 1200 in accordance with some embodiments. The operation flow/algorithmic structure 1200 may be performed or implemented by a base station such as, for example, the base station 108 or the base station 1400; or components thereof, for example, baseband processor circuitry 1404A.

The operation flow/algorithmic structure 1200 may include, at 1210, generating a periodic SSB. Base station 108 may generate and transmit Type-1 SSBs, e.g., periodic SSBs on an SCell. The SCell may be configured but not being activated for the UE 104. In some embodiments, the Type-1 SSB on SCell may be transmitted to the UE 104 by base station 118, while the UE 104 is connected to a PCell provided by base station 108.

The operation flow/algorithmic structure 1200 may include, at 1220, generating a configuration of one or more on-demand SSB configurations. Each on-demand SSB configuration may include an on-demand SSB pattern that has a periodicity or a position in SSB burst fields. The on-demand SSB configuration may be associated with the SCell.

In some embodiments, the configuration may be an RRC configuration. The RRC configuration may include one or more SCell configurations, and each SCell configuration may include one or more on-demand SSB configurations.

The operation flow/algorithmic structure 1200 may include, at 1230, generating an activation command. The activation command may trigger or activate a Type-2 on-demand SSB configuration of one or more on-demand SSB configurations of the SCell.

In some embodiments, the activation command may be an RRC signaling. For example, the RRC configuration that configures the SCell may include an IE to activate one of the configured on-demand SSB configurations.

In some embodiments, the activation command may be a MAC CE. The MAC CE may activate on-demand SSB configuration on a single cell or multiple cells. In some instances, the MAC CE may activate the SCell as well. The MAC CE may be used to deactivate the on-demand SSB configuration or the SCell. In some instances, activation or deactivation of on-demand SSB may be independent of activation or deactivation of the corresponding SCell.

In some embodiments, the activation command may be a DCI. The DCI may be a UE-specific DCI format (e.g., DCI format x_0 or x_1), a UE-specific format without scheduling data (e.g., DCI format 1_1), or a group-specific format.

The operation flow/algorithmic structure 1200 may include, at 1240, generating an on-demand SSB based on the activated on-demand SSB configuration. Base station 108 may generate and transmit on-demand SSB occasions consistent with the activated on-demand SSB configuration. Base station 108 may sometimes send the on-demand SSB occasions K slots after generating or transmitting the on-demand SSB activation command.

In some embodiments, base station 118 may provide SCell and base station 108 may provide configuration information to UE 104. In some embodiments, base station 118 may generate and send a message to base station 108, and base station 108 may receive and process the message. The message may indicate that Type-2 on-demand SSB is enabled or activated on SCell. The message may include configuration information for the Type-2 on-demand SSB configuration. The message may be transmitted on an X interface between base station 118 and base station 108.

The base station 108 may generate a measurement configuration and send it to the UE 104. Base station 108 may generate the measurement configuration based on the Type-2 on-demand SSB configuration received from neighbor base station 118. The measurement configuration may be an SMTC window configuration.

In some embodiments, base station 108 may generate and send a request to base station 118, and neighbor base station 118 may receive and process the request. The request may include a request transmission of Type-2 on-demand SSB from neighbor base station 118. The request may be sent over the X interface.

In response to the request message, base station 118 may generate and send an acknowledgment message to base station 108. The acknowledgment message may include Type-2 SSB configuration information. Base station 118 may send the acknowledgment message via X interface.

Base station 108 may use the Type-2 SSB configuration information received from base station 118 to configure or update the measurement configuration of UE 104. The measurement configuration may include SMTC window configuration. Base station 108 may configure measurement configuration based on Type-1 or Type-2 SSB configuration information received from base station 118.

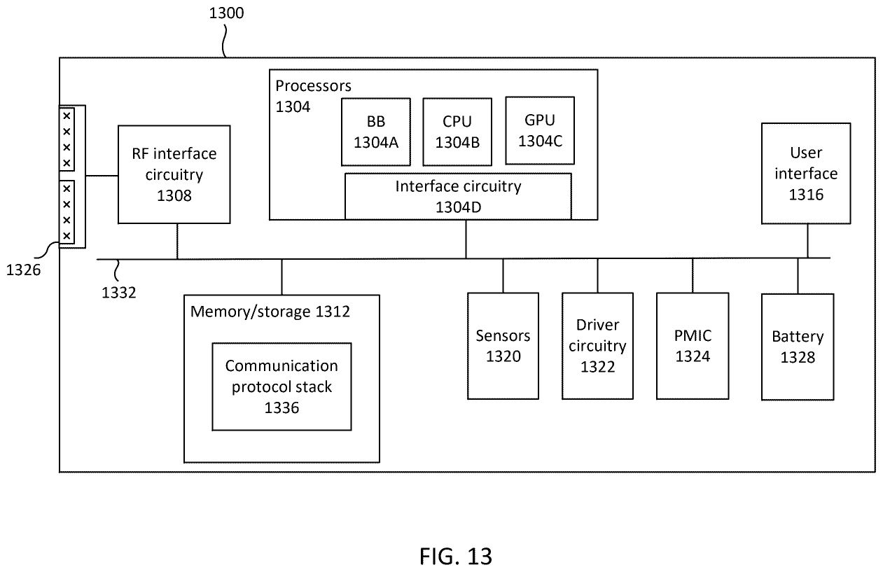

FIG. 13 illustrates a UE 1300 in accordance with some embodiments. The UE 1300 may be similar to and substantially interchangeable with the UE 104.

The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1300 may include processors 1304, RF interface circuitry 1308, memory/storage 1312, user interface 1316, sensors 1320, driver circuitry 1322, power management integrated circuit (PMIC) 1324, antenna 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, or optical connection that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein. The processors 1304 may also include interface circuitry 1304D to enable communication by, for example, communicatively coupling the processor circuitry with one or more other components of the UE 1300.

In some embodiments, the baseband processor circuitry 1304A may access a communication protocol stack 1336 in the memory/storage 1312 to communicate over a 3GPP-compatible network. In general, the baseband processor circuitry 1304A may access the communication protocol stack 1336 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the UE 1300 to perform various operations described herein.

The memory/storage 1312 includes any type of volatile or non-volatile memory that may be distributed throughout the UE 1300. In some embodiments, some of the memory/storage 1312 may be located on the processors 1304 themselves (for example, memory/storage 1312 may be part of a chipset that corresponds to the baseband processor circuitry 1304A), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, or phased array antennas. The antenna 1326 may have one or more panels designed for specific frequency bands including bands in FR1 or FR2.

The user interface 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1300.

The sensors 1320 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within or connected to the UE 1300. For example, driver circuitry 1322 may include a display driver to control and allow access to a display device, a touchscreen driver to control and allow access to a touchscreen interface, sensor drivers to obtain sensor readings of sensors 1320, and control and allow access to sensors 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

A battery 1328 may power the UE 1300, although in some examples, the UE 1300 may be mounted deployed in a fixed location and may have a power supply coupled to an electrical grid. The battery 1328 may be a lithium-ion battery, a metal-air battery, such as a zinc-air battery, an aluminum-air battery, a lithium-air battery, and the like. In some implementations, such as in vehicle-based applications, the battery 1328 may be a typical lead-acid automotive battery.

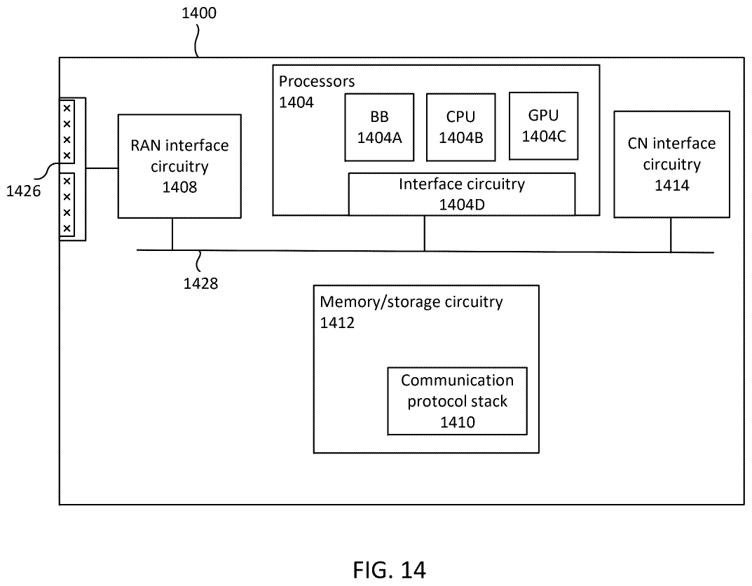

FIG. 14 illustrates a network device 1400 in accordance with some embodiments. The network device 1400 may be similar to and substantially interchangeable with base station 108.

The network device 1400 may include processors 1404, RF interface circuitry 1408 (if implemented as a base station), core network (CN) interface circuitry 1414, memory/storage circuitry 1412, and antenna structure 1426.

The components of the network device 1400 may be coupled with various other components over one or more interconnects 1428.

The processors 1404, RF interface circuitry 1408, memory/storage circuitry 1412 (including communication protocol stack 1410), antenna structure 1426, and interconnects 1428 may be similar to like-named elements shown and described with respect to FIG. 13.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage circuitry 1412 to cause the UE 1300 to perform operations as described herein. The processors 1404 may also include interface circuitry 1404D to communicatively couple the processor circuitry with one or more other components of the network device 1400.

The CN interface circuitry 1414 may provide connectivity to a core network, for example, a 5th Generation Core network (5GC) using a 5GC-compatible network interface protocol such as carrier Ethernet protocols or some other suitable protocol. Network connectivity may be provided to/from the network device 1400 via a fiber optic or wireless backhaul. The CN interface circuitry 1414 may include one or more dedicated processors or FPGAs to communicate using one or more of the aforementioned protocols. In some implementations, the CN interface circuitry 1414 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: processing a periodic synchronization signal block (SSB) on a secondary cell (SCell); processing a configuration including one or more on-demand (OD)-SSB configurations of the SCell; processing an activation command associated with an OD-SSB configuration of the one or more OD-SSB configurations; and processing an OD-SSB received on the SCell in accordance with the OD-SSB configuration that is indicated by the activation command.

Example 2 includes the method of example 1 or some other examples herein, wherein the OD-SSB configuration includes an OD-SSB pattern.

Example 3 includes the method of examples 1 or 2 or some other example herein, wherein the activation command includes an indication associated with the OD-SSB configuration.

Example 4 includes the method of any of examples 1-3 or some other example herein, wherein the activation command is included in a radio resource control (RRC) information element (IE).

Example 5 includes the method of any of examples 1-4 or some other example herein, wherein the RRC IE is to add the SCell or modify the OD-SSB configuration of the SCell

Example 6 includes the method of any of examples 1-5 or some other example herein, wherein the activation command is included in a medium access control (MAC) control element (CE).

Example 7 includes the method of any of examples 1-6 or some other example herein, wherein the MAC CE includes a cell identifier (ID) field associated with the SCell or an OD-SSB configuration ID field associated with the OD-SSB configuration.

Example 8 includes the method of any of examples 1-7 or some other example herein, wherein the MAC CE has a fixed size.

Example 9 includes the method of any of examples 1-8 or some other example herein, the SCell is a first SCell and the OD-SSB configuration is a first OD-SSB configuration; the configuration includes a second OD-SSB configuration for a second SCell; and the MAC CE includes: a first OD-SSB configuration ID field associated with the first OD-SSB configuration; a second OD-SSB configuration ID field associated with the second OD-SSB configuration; a first indication field to indicate a presence of the first OD-SSB configuration field; and a second indication field to indicate a presence of the second OD-SSB configuration field.

Example 10 includes the method of any of examples 1-9 or some other example herein, wherein the MAC CE has a variable size.

Example 11 includes the method of any of examples 1-10 or some other example herein, wherein the MAC CE includes: a first cell identifier (ID) field to activate or deactivate the first SCell; and a second cell ID field to activate or deactivate the second SCell.

Example 12 includes the method of any of examples 1-11 or some other example herein, wherein the activation command for the SCell is included in a downlink control information (DCI).

Example 13 includes the method of any of examples 1-12 or some other example herein, wherein the SCell is a first SCell, and the method further comprises: processing the DCI received on a sconed SCell, second SCell different from the first SCell.

Example 14 includes the method of any of examples 1-13 or some other example herein, wherein the DCI includes: a cell indicator field associated with the SCell; or an OD-SSB configuration identifier (ID) field associated with the OD-SSB configuration.

Example 15 includes the method of any of examples 1-14 or some other example herein, wherein: the DCI is a group-specific DCI format, and the DCI includes: a first OD-SSB configuration indicator field and a second OD-SSB configuration indicator field; the SCell is a first SCell, the OD-SSB configuration is a first OD-SSB configuration, and the configuration includes: a first indicator field to associate the first OD-SSB configuration with the first SCell; and a second indicator field to associate a second OD-SSB configuration of the one or more OD-SSB configurations with a second SCell.

Example 16 includes the method of any of examples 1-15 or some other example herein, further including: performing an inter-cell measurement based on the periodic SSB or the OD-SSB.

Example 17 includes the method of any of examples 1-16 or some other example herein, wherein the configuration is a radio resource control (RRC) configuration.

Example 18 includes a method including: generating a periodic synchronization signal block (SSB) on a secondary cell (SCell); generating a configuration including one or more on-demand (OD)-SSB configurations of a secondary cell (SCell); generating an activation command associated with an OD-SSB configuration of one or more OD-SSB configurations; and generating an OD-SSB to be transmitted on the SCell in accordance with the OD-SSB configuration.

Example 19 includes the method of example 18 or some other example herein, wherein the OD-SSB configuration includes an OD-SSB pattern.

Example 20 includes the method of examples 18 or 19 or some other example herein, wherein the activation command includes an indication associated with the OD-SSB configuration.

Example 21 includes the method of any of examples 18-20 or some other example herein, wherein the activation command is included in a radio resource control (RRC) information element (IE).

Example 22 includes the method of any of examples 18-21 or some other example herein, wherein the RRC IE is to add the SCell or modify the OD-SSB configuration of the SCell.

Example 23 includes the method of any of examples 18-22 or some other example herein, wherein the activation command is included in a medium access control (MAC) control element (CE).

Example 24 includes the method of any of examples 18-23 or some other example herein, wherein the MAC CE includes a cell identifier (ID) field associated with the SCell or an OD-SSB configuration ID field associated with the OD-SSB configuration.

Example 25 includes the method of any of examples 18-24 or some other example herein, the SCell is a first SCell and the OD-SSB configuration is a first OD-SSB configuration; the configuration includes a second OD-SSB configuration for a second SCell; and the MAC CE includes: a first OD-SSB configuration ID field associated with the first OD-SSB configuration; a second OD-SSB configuration ID field associated with the second OD-SSB configuration; a first indication field to indicate a presence of the first OD-SSB configuration field; and a second indication field to indicate a presence of the second OD-SSB configuration field.

Example 26 includes the method of any of examples 18-25 or some other example herein, wherein the MAC CE has a variable size.

Example 27 includes the method of any of examples 18-26 or some other example herein, wherein the first and second OD-SSBs are activated, the MAC CE includes: a first cell identifier (ID) field to activate or deactivate the first SCell; and a second cell ID field to activate or deactivate the second SCell.

Example 28 includes the method of any of examples 18-27 or some other example herein, wherein the activation command is included in a downlink control information (DCI).

Example 29 includes the method of any of examples 18-28 or some other example herein, wherein the SCell is a first SCell, and the method further comprises: generating the DCI to be transmitted on a sconed SCell, second SCell different from the first SCell.

Example 30 includes the method of any of examples 18-29 or some other example herein, a cell indicator field associated with the SCell; or an OD-SSB configuration identifier (ID) field associated with the OD-SSB configuration.

Example 31 includes the method of any of examples 18-30 or some other example herein, wherein: the DCI is a group-specific DCI format, and the DCI includes: a first OD-SSB configuration indicator field and a second OD-SSB configuration indicator field; and the SCell is a first SCell, the OD-SSB configuration is a first OD-SSB configuration, and the configuration includes: a first indicator field to associate the first OD-SSB configuration with the first SCell; and second indicator field to associate a second OD-SSB configuration with a second SCell.

Example 32 includes the method of any of examples 18-31 or some other example herein, further including: generating a measurement configuration for an inter-cell measurement based on the periodic SSB or the OD-SSB.

Example 33 includes the method of any of examples 18-32 or some other example herein, further including: processing, on an interface, a message received from a neighbor base station, the signal including an indication or an update of the OD-SSB configuration.

Example 34 includes the method of any of examples 18-33 or some other example herein, further including: configuring an SSB-based measurement timing configuration (SMTC) window, based on the message, wherein the SMTC window is used for radio resource management (RRM) measurements.

Example 35 includes the method of any of examples 18-34 or some other example herein, further including: generating a request to be transmitted to the neighbor base station to trigger transmission of OD-SSB for radio resource management (RRM) measurements; processing an acknowledgment associated with the request; and configuring an SSB-based measurement timing configuration (SMTC) window based on the acknowledgment.

Example 36 includes the method of any of examples 18-35 or some other example herein, wherein the O-SSB is transmitted on the SCell of a first radio access network (RAN) node in response to a request message received from a second RAN node.

Another example may include an apparatus comprising means to perform one or more elements of a method described in or related to any of examples 1-36, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Another example may include an apparatus comprising logic, modules, or circuitry to perform one or more elements of a method described in or related to any of examples 1-36, or any other method or process described herein.

Another example may include a method, technique, or process as described in or related to any of examples 1-36, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-36, or portions thereof.

Another example may include a signal as described in or related to any of examples 1-36, or portions or parts thereof.

Another example may include a datagram, information element, packet, frame, segment, PDU, or message as described in or related to any of examples 1-36, or portions or parts thereof, or otherwise described in the present disclosure.

Another example may include a signal encoded with data as described in or related to any of examples 1-36, or portions or parts thereof, or otherwise described in the present disclosure.

Another example may include a signal encoded with a datagram, IE, packet, frame, segment, PDU, or message as described in or related to any of examples 1-36, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-36, or portions thereof.

Another example may include a computer program comprising instructions, wherein execution of the program by a processing element is to cause the processing element to carry out the method, techniques, or process as described in or related to any of examples 1-36, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a periodic synchronization signal block (SSB) received on a secondary cell (SCell);
processing a configuration including one or more on-demand (OD)-SSB configurations of the SCell;
processing an activation command to activate a first OD-SSB configuration of the one or more OD-SSB configurations; and
processing an OD-SSB received on the SCell in accordance with the first OD-SSB configuration.

2. The method of claim 1, wherein the first OD-SSB configuration includes an OD-SSB pattern.

3. The method of claim 1, wherein the activation command is included in a radio resource control (RRC) information element (IE), and wherein the RRC IE is to add the SCell or modify a prior OD-SSB configuration of the SCell.

4. The method of claim 1, wherein the activation command is included in a medium access control (MAC) control element (CE), and wherein the MAC CE includes a cell identifier (ID) field to identify the SCell and an OD-SSB configuration ID field to indicate the first OD-SSB configuration.

5. The method of claim 4, wherein the SCell is a first SCell, the OD-SSB configuration ID field is a first OD-SSB configuration ID field, and wherein the MAC CE includes:
a second OD-SSB configuration ID field to indicate a second OD-SSB configuration for a second SCell;
a first indication field to indicate a presence of the first OD-SSB configuration field; and
a second indication field to indicate a presence of the second OD-SSB configuration field.

6. The method of claim 1, wherein the activation command for the SCell is included in a downlink control information (DCI), and wherein the DCI includes:
a cell indicator field to identify the SCell; or
an OD-SSB configuration identifier (ID) field to indicate the first OD-SSB configuration.

7. The method of claim 6, wherein the SCell is a first SCell, and wherein the DCI is received on a second SCell.

8. The method of claim 6, wherein the SCell is a first SCell, wherein the OD-SSB configuration ID field is a first OD-SSB configuration ID field, and wherein:
the DCI is a group-specific DCI format, and the DCI includes the first OD-SSB configuration indicator field and a second OD-SSB configuration indicator field to indicate a second OD-SSB configuration; and
the configuration includes:
a first indicator field to associate the first OD-SSB configuration with the first SCell; and
a second indicator field to associate the second OD-SSB configuration with a second SCell.

9. A method comprising:
generating, for transmission, a periodic synchronization signal block (SSB) on a secondary cell (SCell);
generating, for transmission, a configuration including one or more on-demand (OD)-SSB configurations of a secondary cell (SCell);
generating, for transmission, an activation command to activate a first OD-SSB configuration of the one or more OD-SSB configurations; and
generating an OD-SSB to be transmitted on the SCell in accordance with the first OD-SSB configuration.

10. The method of claim 9, wherein the OD-SSB configuration includes an OD-SSB pattern.

11. The method of claim 9, wherein the activation command is included in a radio resource control (RRC) information element (IE), wherein the RRC IE is to add the SCell or modify a prior OD-SSB configuration of the SCell.

12. The method of claim 9, wherein the activation command is included in a medium access control (MAC) control element (CE), and wherein the MAC CE includes a cell identifier (ID) field to identify the SCell and an OD-SSB configuration ID field to indicate the first OD-SSB configuration.

13. The method of claim 12, wherein the SCell is a first SCell, the OD-SSB configuration ID field is a first OD-SSB configuration ID field, and wherein the MAC CE includes:
a second OD-SSB configuration ID field to indicate a second OD-SSB configuration for a second SCell;
a first indication field to indicate a presence of the first OD-SSB configuration field; and
a second indication field to indicate a presence of the second OD-SSB configuration field.

14. The method of claim 9, wherein the activation command is included in a downlink control information (DCI), and wherein the DCI includes:
a cell indicator field to identify the SCell; or
an OD-SSB configuration identifier (ID) field to indicate the first OD-SSB configuration.

15. The method of claim 14, wherein the SCell is a first SCell, wherein the OD-SSB configuration ID field is a first OD-SSB configuration ID field, and wherein:
the DCI is a group-specific DCI format, and the DCI includes the first OD-SSB configuration indicator field and a second OD-SSB configuration indicator field to indicate a second OD-SSB configuration; and
the configuration includes:
a first indicator field to associate the first OD-SSB configuration with the first SCell; and
a second indicator field to associate the second OD-SSB configuration with a second SCell.

16. The method of claim 9, wherein:
the SCell is a first SCell, and wherein the activation command is to trigger a second SCell to transmit a downlink control information (DCI) to activate the first OD-SSB configuration; or
wherein the OD-SSB is transmitted on the SCell of a first radio access network (RAN) node in response to a request message received from a second RAN node.

17. The method of claim 9, further comprising:
processing a message received from a neighbor base station, the message including an indication or an update of the first OD-SSB configuration; and
configuring, based on the message, an SSB-based measurement timing configuration (SMTC) window for a user equipment (UE) to perform radio resource management (RRM) measurements.

18. The method of claim 9, further comprising:
generating a request to be transmitted to a neighbor base station to trigger transmission of the OD-SSB for radio resource management (RRM) measurements;
processing an acknowledgment associated with the request; and
configuring an SSB-based measurement timing configuration (SMTC) window for a user equipment (UE) based on the acknowledgment.

19. An apparatus comprising:
processor circuitry to:
receive configuration information that includes a plurality of on-demand (OD)-synchronization signal block (SSB) configurations of a secondary cell (SCell);
receive an activation command to activate a first OD-SSB configuration of the plurality of OD-SSB configurations; and
receive an OD-SSB on the SCell in accordance with the first OD-SSB configuration; and
interface circuitry coupled to the processor circuitry to enable communication.

20. The apparatus of claim 19, wherein the activation command is included in a radio resource control (RRC) message, a medium access control (MAC) control element (CE), or a downlink control information (DCI).
